(19) United States
(12) Patent Application Publication
(10) Pub. No.: US 2025/0242313 A1
(43) Pub. Date: Jul. 31, 2025

(54) COMPOSITE FILTER MEDIA

(71) Applicant: ENTEGRIS, INC., Billerica, MA (US)

(72) Inventors: KwokShun Cheng, Nashua, NH (US); Jad A. Jaber, Westford, MA (US); Tony Yu, Quincy, MA (US); Maybelle Woo, Dedham, MA (US); Dongzhu Wu, Hangzhou (CN); James Hamzik, North Billerica, MA (US)

(21) Appl. No.: 19/182,545

(22) Filed: Apr. 17, 2025

Related U.S. Application Data
(63) Continuation of application No. 17/354,921, filed on Jun. 22, 2021.
(60) Provisional application No. 63/043,007, filed on Jun. 23, 2020.

(51) Int. Cl. B01D 71/56; B01D 67/00; B01D 69/02; B01D 69/10; B01D 69/12; B01D 71/26

(52) U.S. Cl. CPC B01D 71/56; B01D 67/0002; B01D 67/0088; B01D 69/02; B01D 69/107; B01D 69/1214; B01D 71/261; B01D 71/262; B01D 2201/12; B01D 2201/18

(57) ABSTRACT

Provided are certain composite membranes useful for removing various impurities from liquids. In certain aspects, the composite membranes comprise a hydrophobic polymer having a polyamide coated thereon, and in other aspects, such composite membranes having certain acrylic polymers coated thereon. The composite membranes are useful in the removal of various impurities in liquids, such as those encountered in industrial and life sciences processes.

### CROSS-REFERENCE TO RELATED APPLICATIONS

This application is a continuation of U.S. patent application Ser. No. 17/354,921 filed Jun. 22, 2021, which claims the benefit under 35 USC 119 of U.S. Provisional Patent Application No. 63/043,007 filed Jun. 23, 2020, the disclosures of which are hereby incorporated herein by reference in their entirety.

### TECHNICAL FIELD

The present disclosure relates to composite filter media or membranes which include a porous polymeric filter which has been coated with a layer comprising a polyamide polymer.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

To perform a filtration function, a filter includes a filter membrane that is responsible for removing unwanted material from a fluid that passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 microns. Membranes with average pore size of from about 0.001 to about 0.05 micron are sometimes classified as ultrafilter membranes. Membranes with pore sizes between about 0.05 and 10 microns are sometimes referred to as microporous membranes.

A filter membrane having micron or sub-micron-range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

The removal of ionic materials such as dissolved anions or cations from solutions is important in many industries, such as the microelectronics industry, where ionic contaminants and particles in very small concentrations can adversely affect the quality and performance of microprocessors and memory devices. The ability to prepare positive and negative photoresists with low levels of metal ion contaminants, or the ability to deliver isopropyl alcohol used in Maragoni drying for wafer cleaning with low part per billion or part per trillion levels of metal ion contaminants is highly desirable and are just two examples of the needs for contamination control in semiconductor manufacturing. Colloidal particles, which can be positively or negatively charged depending on the colloid chemistry and solution pH, can also contaminate process liquids and need to be removed. Dissolved ionic materials can be removed by way of a non-sieving filtration mechanism, by microporous filter membranes that are made of polymeric materials that attract dissolved ionic materials. Examples of such microporous membranes are made from chemically inert, low surface energy polymers like ultrahigh molecular weight polyethylene (“UPE”), polytetrafluoroethylene, and the like. Nylon filter membranes, in specific, are used in a variety of different filtration applications in the semiconductor processing industry, due to the ability to form nylon into filter membranes that exhibit high permeability and due to good sieving and non-sieving filtration behavior of nylon.

### SUMMARY

The field of microelectronic device processing requires steady improvements in processing materials and methods to sustain parallel steady improvements in the performance (e.g., speed and reliability) of microelectronic devices. Opportunities to improve microelectronic device fabrication exist in all aspects of the manufacturing process, including methods and systems for filtering liquid materials.

A large range of different types of liquid materials are used as process solvents, cleaning agents, and other processing solutions, in microelectronic device processing. Many if not most of these materials are used at a very high level of purity. As an example, liquid materials (e.g., solvents) used in photolithography processing of microelectronic devices must be of very high purity. Specific examples of liquids that are used in microelectronic device processing include process solutions for spin-on-glass (SOG) techniques, for backside anti-reflective coating (BARC) methods, and for photolithography. Some of these liquid materials are acidic. To provide these liquid materials at a high level of purity for use in microelectronic device processing, a filtering system must be highly effective to remove various contaminants and impurities from the liquid, and must be stable (i.e., not degrade or introduce contaminants) in the presence of the liquid material being filtered (e.g., an acidic material).

In one aspect, a composite porous filter membrane comprises:
a porous hydrophobic polymeric filter media having a coating thereon, wherein said coating is a polyamide polymer which is soluble in formic acid, wherein said membrane has:
   (i) a surface energy of greater than about 30 dynes/cm;
   (ii) an isopropanol flowtime of about 150 to about 20,000 seconds/500 mL, measured at 14.2 psi.

We believe that the polyamide coating formed on the surface of the porous hydrophobic polymeric filter media is a porous coating, thereby providing a substantially greater surface area for the polyamide coating surface. When a formic acid solution of the polyamide as described herein is placed on a glass plate and solvent allowed to evaporate, the film thus formed is opaque, thus indicating a porous rather than non-porous film is formed on hydrophobic surfaces. It is believed that this feature thus provides improved non-sieving filtration performance.

In a second aspect, a composite porous filter membrane comprises a porous hydrophobic polymeric filter membrane having coated thereon a polyamide coating as a first coating, wherein said polyamide is soluble in formic acid, thereby providing a polyamide-coated membrane, and wherein said membrane has a second coating thereon, which is the free-radical reaction product of (i) at least one crosslinker; and (ii) at least one monomer, in the presence of a photo-initiator.

In another aspect, disclosed herein is a method for removing an impurity from a liquid, which comprises contacting the liquid with the composite membranes described herein.

### BRIEF DESCRIPTION OF THE DRAWINGS

The disclosure may be more completely understood in consideration of the following description of various illustrative embodiments in connection with the accompanying drawings

FIG. 1 (which is schematic and not necessarily to scale) shows an example of a filter product as described herein.

FIG. 2 is a simplified depiction of a porous filter membrane coated with a polyamide, showing the base membrane (the hydrophobic polymeric filter membrane) having coated thereon a polyamide. As noted below, the polyamide coating does not necessarily form a continuous coating on the base membrane as shown.

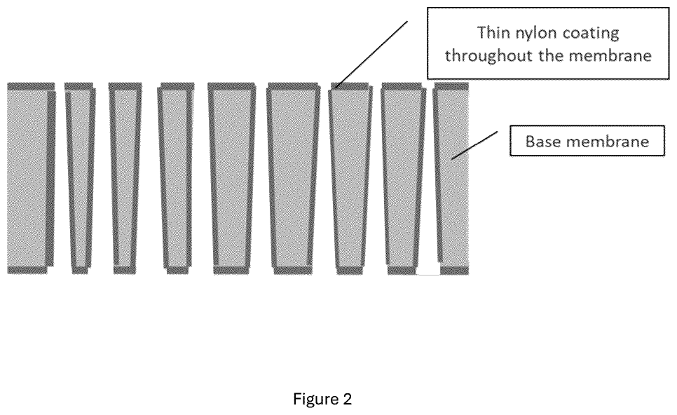

FIG. 3 is an illustration of the surface tension of methanol and water mixtures at 20° C. Surface tension (nM/m at 20° C.) is plotted versus mass methanol in water (%).

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g. 1 to 5 includes 1, 1.5, 2, 2.75, 3, 3.80, 4 and 5).

As noted above, in a first aspect, a composite porous filter membrane comprises:
a porous hydrophobic polymeric filter media having a coating thereon, wherein said coating is a polyamide polymer which is soluble in formic acid, wherein said membrane has:
   i. a surface energy of greater than about 30 dynes/cm; and
   ii. an isopropanol flow time of about 150 to about 20,000 seconds/500 mL, measured at 14.2 psi.

In certain embodiments, the surface energy is about 30 to about 100, about 30 to about 85 or about 30 to about 65 dynes/cm.

In certain embodiments, said membrane has a bubble point of about 20 to 200 psi, when measured using HFE 7200 at a temperature of about 22° C. and/or said membrane has the capacity to bind Ponceau S dye of between about 1 and about 10 μg/cm² and capacity to bind methylene blue dye (MB DBC) of between about 1 and about 10 μg/cm². In certain embodiments, the membranes have the capacity to bind Ponceau S dye of about 8 to about 10 μg/cm²; in other embodiments, the membranes have the capacity to bind Ponceau S dye of about 9.2 μg/cm².

In certain embodiments, the isopropanol flowtime is about 6,000 to about 10,000 seconds/500 mL, and in other embodiments about 8,000 seconds/500 mL.

As noted above, the composite membranes described herein are useful as filtration media for removing impurities from various fluids. In certain embodiments of the first and second aspects, the polyamide coating applied to the hydrophobic filter media or membrane does not completely cover or encapsulate the hydrophobic filter media or membrane, but rather forms a semi-continuous or partial coating on the underlying porous hydrophobic membrane. Similarly, in the second aspect, where a free radical polymerization is conducted in the presence of the polyamide-coated membrane, the resulting cured or cross-linked polymeric coating, in certain embodiments, does not completely cover or encapsulate the surfaces of the membrane, but again forms a semi-continuous or partial coating on the polyamide-coated porous hydrophobic membrane structure.

In certain embodiments, the underlying hydrophobic porous polymer filter material is formed from a polymeric material, a mixture of different polymeric materials, or a polymeric material and a non-polymeric material. Polymeric materials forming the filter can be crosslinked together to provide a filter structure with a desired degree of integrity.

Polymeric materials that can be used to form the underlying porous filter membranes of the disclosure are hydrophobic polymers, which in certain embodiments possess a surface energy of less than about 40 dynes/cm. In some embodiments, the filter hydrophobic polymer membrane includes a polyolefin or a halogenated polymer. Exemplary polyolefins include polyethylene (PE), polypropylene (PP), polymethylpentene (PMP), polybutene (PB), polyisobutylene (PIB), and copolymers of two or more of ethylene, propylene, and butylene. In a further particular embodiment, filter material includes ultrahigh molecular weight polyethylene (UPE). UPE filter materials, such as UPE membranes, are typically formed from a resin having a molecular weight (viscosity average molecular weight) greater than about 1×10⁶ Daltons (Da), such as in the range of about 1×10⁶-9×10⁶ Da, or 1.5×10⁶-9×10⁶ Da. Crosslinking between polyolefin polymers such as polyethylene can be promoted by use of heat or crosslinking chemicals, such as peroxides (e.g., dicumyl peroxide or di-tert-butyl peroxide), silanes (e.g., trimethoxyvinylsilane), or azo ester compounds (e.g., 2,2′-azo-bis(2-acetoxy-propane). Exemplary halogenated polymers include polytetrafluoroethylene (PTFE), polychlorotrifluoro-ethylene (PCTFE), fluorinated ethylene polymer (FEP), polyhexafluoropropylene, and polyvinylidene fluoride (PVDF).

In other embodiments, the filter material includes a polymer chosen from polyimides, polysulfones, polyether-sulfones, polyarylsulfone polyamides, polyacrylates, polyesters, polyamide-imides, celluloses, cellulose esters, polycarbonates, or combinations thereof.

In another embodiment, the underlying hydrophobic porous filter membrane can be chosen from commercially available hydrophobic membranes such as those prepared from ultrahigh molecular r weight polyethylene, polypropylene, polycarbonate, poly(tetrafluoro ethylene), polyvinylidene fluoride, polyarylsulfones and the like.

The composite membranes, starting with a porous hydrophobic filter membrane such as those comprised of ultrahigh molecular weight polyethylene, are treated with a solution of a polyamide polymer in, for example, formic acid. Once the membrane is coated, it is transferred to a mixing vessel which contains an aqueous solution comprising water. The resulting membrane is then subjected to one or more cleaning steps involving passage through aqueous and lower alcoholic cleaning vessels. Upon drying, the process provides the composite membranes of the first aspect. In one embodiment, the cleaning steps comprise two serial vessels comprising water and one comprising a lower, e.g., C₁-C₄ alcohol in between the two serial vessels of water.

Alternately, in a second aspect as referred to above, the composite membrane, starting with a porous hydrophobic filter membrane such as those comprised of ultrahigh molecular weight polyethylene, is treated with a solution of a polyamide polymer in, for example, formic acid. Once the membrane is coated, it is transferred to a mixing vessel which contains an aqueous solution comprising (i) at least one crosslinker, (ii) at least one monomer, and (iii) at least one photoinitiator, hereinafter referred to as the “monomer solution”. The thus-coated membrane can then be subjected to UV light in order to initiate a free radical polymerization at the surface of the polyamide coating with the (i) at least one crosslinker and the (ii) at least one monomer. The resulting membrane is then subjected to one or more cleaning steps involving passage through aqueous and lower alcoholic cleaning vessels. Upon drying, the process provides the composite membranes of second aspect.

In certain embodiments, the composite membranes of this second aspect possess the following characteristics:
(i) an isopropanol flowtime of about 150 to 20,000 seconds/500 mL, measured at 14.2 psi;
(ii) has a bubble point of about 20 to 200 psi, when measured using ethoxy-nonafluorobutane HFE 7200 at a temperature of about 22° C.; and
(iii) has the capacity to bind Ponceau S dye of between about 1 and 30 μg/cm² and capacity to bind methylene blue dye (MB DBC) of between about 1 and 30 μg/cm².

In certain embodiments, the surface energy is greater than 30, from about 30 to 100, or about 30 to 85, or about 30 to 65 dynes/cm.

The polyamide polymers, also commonly known as “nylons”, referred to above are typically understood to include copolymers and terpolymers that include recurring amido groups in a polymeric backbone. Generally, nylon and polyamide resins include copolymers of a diamine and a dicarboxylic acid, or homopolymers of a lactam and an amino acid. In certain embodiments, nylons for use in fabricating filter membrane as described herein include copolymers of hexamethylene diamine and adipic acid (nylon 6,6), copolymers of hexamethylene diamine and sebacic acid (nylon 610), homopolymers of polycaprolactam (nylon 6) and copolymers of tetramethylenediamine and adipic acid (nylon 46). Nylon polymers are available in a wide variety of grades, which vary appreciably with respect to molecular weight, within the range from about 15,000 to about 42,000 (number average molecular weight) and in other characteristics. All such polyamides, as contemplated herein, are soluble in formic acid, but generally insoluble in aqueous solutions. Such polyamides are utilized as a dilute solution in formic acid. In one embodiment, the polyamide is utilized in a concentration of about 1 to 4 weight percent in formic acid.

The crosslinkers as referred to above are uncharged difunctional (i.e., having two carbon-carbon double bonds) vinyl, acrylic or methacrylic monomeric species, optionally having an amide functionality. Non-limiting examples of such crosslinkers include methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, and ethylene glycol divinyl ether.

The monomers as referred to herein are charged or uncharged vinyl, acrylic or methacrylic monomeric species.

Non-limiting examples of monomers with a positive charge that can be used in embodiments of the disclosure can include, but are not limited to, 2-(dimethylamino)ethyl hydrochloride acrylate, [2-(acryloyloxy)ethyl]trimethylammonium chloride, 2-aminoethyl methacrylate hydrochloride, N-(3-aminopropyl) methacrylate hydrochloride, 2-(dimethylamino)ethyl methacrylate hydrochloride, [3-(methacryloylamino)propyl]trimethylammonium chloride solution, [2-(methacryloyloxy)ethyl]trimethylammonium chloride, acrylamidopropyl trimethylammonium chloride, 2-aminoethyl methacrylamide hydrochloride, N-(2-aminoethyl) methacrylamide hydrochloride, N-(3-aminopropyl)-methacrylamide hydrochloride, diallyldimethylammonium chloride, allylamine hydrochloride, vinyl imidazolium hydrochloride, vinyl pyridinium hydrochloride, and vinyl benzyl trimethyl ammonium chloride, either individually or in combinations of two or more thereof. In a particular embodiment, the monomer with positive charge includes acrylamido propyl trimethylammonium chloride (APTAC). It should be appreciated that some monomers with a positive charge listed above, comprise a quaternary ammonium group and are naturally charged while other monomers with a positive charge such as comprising primary, secondary and tertiary amines are adjusted to create charge by treatment with an acid. Monomers which can be positively charged, either naturally or by treatment, can be polymerized and cross-linked with a cross-linker to form a coating on the porous membrane.

Examples of monomers with negative charges that can be used can include, but are not limited to, 2-ethylacrylic acid, acrylic acid, 2-carboxy ethyl acrylate, 3-sulfopropyl acrylate potassium salt, 2-propyl acrylic acid, 2-(trifluoromethyl) acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-l-propanesulfonic acid, 3-methacrylamido phenyl boronic acid, vinyl sulfonic acid, and vinyl phosphonic acid, either individually or combinations of two or more thereof. In a particular embodiment, the monomer with negative charge includes sulfonic acid moieties. It should be appreciated that some monomers with a negative charge listed above, comprise a strong acid group and are naturally charged while other monomers with a negative charge comprising weak acids are adjusted to create charge by treatment with base. Monomers which are negatively charged either naturally or by treatment can be polymerized and cross-linked with a cross-linker to form a coating on a porous membrane that is negatively charged in an organic solvent.

Examples of neutral monomers that can be used can include, but are not limited to, acryl amide, N,N dimethyl acrylamide, N-(hydroxyethyl) acrylamide, diacetone acrylamide, N-[tris(hydroxymethyl)methyl]acrylamide, N-(isobutoxymethyl)acrylamide, N-(3-methoxypropyl)acrylamide, 7-[4-(trifluoromethyl)coumarin]acrylamide, N-isopropyl acrylamide, 2-(dimethylamino)ethyl acrylate, 1,1,1,3,3,3-hexafluoroisopropyl acrylate, ethyl acrylate, 2-hydroxyethyl acrylate, butyl acrylate, ethylene glycol methyl ether acrylate, 4-hydroxybutyl acrylate, hydroxypropyl acrylate, 4-acetoxyphenethyl acrylate, benzyl acrylate, 1-vinyl-2-pyrrolidinone, vinyl acetate, ethyl vinyl ether, vinyl 4-tert-butylbenzoate, and phenyl vinyl sulfone.

The photo-initiators are, in one embodiment, chosen from those recognized as Type I photo-initiators. Without wishing to be bound by theory, the type I photoinitiator undergoes a unimolecular bond cleavage upon irradiation to yield free radicals. Examples of suitable initiators include various persulfate salts, such as sodium persulfate and potassium persulfate, 1-hydroxycyclohexyl phenyl ketone, sold under the mark Irgacure 2959 (2-Hydroxy-4′-(2-hydroxyethoxy)-2-methylpropiophenone), and benzoyl peroxide.

The amount of photoinitiator in the monomer solution can be any amount (i.e., concentration) which is sufficiently high to affect the desired free-radical reaction between the crosslinker(s) and monomer(s). Examples of useful amounts of photoinitiator in the monomer solution may be in a range of up to 1 weight percent, e.g., from 0.1 or 0.5 to 4.5 weight percent, or from 1 or 2 to 3 or 4 weight percent.

The type of solvent used for the monomer solution can be any that is effective to allow the monomer solution to dissolve and deliver a useful amount of monomer to surfaces of the hydrophilic polymer. The preferred solvent for the monomer solution is water or water with the addition of an organic solvent. The solvent can include organic solvent, water, or both. Examples of organic solvents include alcohols, especially lower alcohols (for example, C₁ to C₆ alcohols), with isopropanol, methanol, and hexylene glycol being useful examples. The specific solvent used for a particular process, monomer solution, and monomer, can be based on factors such as the type and amount of monomer in the monomer solution, the type of hydrophilic polymer, and other factors. In a solvent that contains both water and organic solvent, the organic solvent may be included in any amount, e.g., in an amount that is less than 90, 75, 50, 40, 30, 20, or 10 percent by weight; as an example, a useful solvent composition may contain from 1 to 10 percent by weight hexylene glycol in water. In one embodiment, the water is deionized water.

The amount of monomer in the monomer solution is in certain embodiments, about 0.5 to 5 weight %, based on the weight of the solution. The amount of crosslinker in the monomer solution is, in certain embodiments, about 0.25 to 3.0 weight %, based on the total weight of the monomer solution. In certain embodiments, the relative amounts of monomer and crosslinker utilized, along with the relative coverage of such ultimate crosslinked or free-radical polymerized coating (upon the hydrophobic membrane coated with a polyamide) is such that the overall, i.e., resulting membrane will have a surface energy of about 30 to 85 dynes/cm.

After the monomer solution has been effectively exposed or coated onto the underlying porous hydrophobic membrane, coated with the polyamide, the resulting membrane is exposed to electromagnetic radiation, typically within the ultraviolet portion of the spectrum, or to another energy source that is effective to cause the photoinitiator to initiate a chemical reaction that results in the reactive moiety of the monomer reacting with and becoming chemically (covalently) bonded to the crosslinker.

In various examples of methods and articles described herein, the composite membrane of described herein can be included in a porous filter membrane. As used herein, a “porous filter membrane” is a porous solid that contains porous (e.g., microporous) interconnecting passages that extend from one surface of the membrane to an opposite surface of the membrane. The passages generally provide tortuous tunnels or paths through which a liquid being filtered must pass. Any particles contained in this liquid that are larger than the pores are either prevented from entering the microporous membrane or are trapped within the pores of the microporous membrane (i.e., are removed by a sieving-type filtration mechanism) as fluid containing the particles passes through the membrane. Particles that are smaller than the pores are also trapped or absorbed onto the pore structure, e.g., may be removed by a non-sieving filtration mechanism. The liquid and possible a reduced amount of particles or dissolved materials pass through the microporous membrane.

Example porous polymeric filter membrane as described herein (considered either before or after the steps for coating the surfaces thereon) can be characterized by physical features that include pore size, bubble point, and porosity.

The porous polymeric filter membrane may have any pore size that will allow the filter membrane to be effective for performing as a filter membrane, e.g., as described herein, including pores of a size (average pore size) sometimes considered as a microporous filter membrane or an ultrafilter membrane. Examples of useful or preferred porous membranes can have an average pore size in a range on from about 0.001 microns to about 1 or 2 microns, e.g., from 0.01 to 0.8 microns, with the pore size be selected based on one or more factors that include: the particle size or type of impurity to be removed, pressure and pressure drop requirements, and viscosity requirements of a liquid being processed by the filter. An ultrafilter membrane can have an average pore size in a range from 0.001 microns to about 0.05 microns. Pore size is often reported as average pore size of a porous material, which can be measured by known techniques such as by Mercury Porosimetry (MP), Scanning Electron Microscopy (SEM), Liquid Displacement (LLDP), or Atomic Force Microscopy (AFM).

Bubble point is also a known feature of a porous membrane. By a bubble point test method, a sample of porous polymeric filter membrane is immersed in and wetted with a liquid having a known surface tension, and a gas pressure is applied to one side of the sample. The gas pressure is gradually increased. The minimum pressure at which the gas flows through the sample is called a bubble point. To determine the bubble point of a porous material a sample of the porous material is immersed in and wetted with ethoxy-nonafluorobutane HFE 7200 (available from 3M) at a temperature of 20-25 degrees Celsius (e.g., 22 degrees Celsius). A gas pressure is applied to one side of the sample by using compressed air and the gas pressure is gradually increased. The minimum pressure at which the gas flows through the sample is called the bubble point. Examples of useful bubble points of a porous polymeric filter membrane that is useful or preferred according to the present description, measured using the procedure described above can be in a range from 5 to 200 psi, e.g., in a range from 20 to 200 psi.

A porous polymer filter layer as described may have any porosity that will allow the porous polymer filter layer to be effective as described herein. Example porous polymer filter layers can have a relatively high porosity, for example a porosity of at least 60, 70 or 80 percent. As used herein, and in the art of porous bodies, a “porosity” of a porous body (also sometimes referred to as void fraction) is a measure of the void (i.e., “empty”) space in the body as a percent of the total volume of the body, and is calculated as a fraction of the volume of voids of the body over the total volume of the body. A body that has zero percent porosity is completely solid.

A porous polymeric filter membrane as described can be in the form of a sheet or hollow fiber having any useful thickness, e.g., a thickness in a range from 5 to 100 microns, e.g., from 10 or 20 to 50 or 80 microns.

A filter membrane as described can be useful for filtering a liquid to remove undesired material (e.g., contaminants or impurities) from the liquid to produce a high purity liquid that can be used as a material of an industrial process. The filter membrane can be useful to remove a dissolved or suspended contaminant or impurity from a liquid that is caused to flow through the coated filter membrane, either by a sieving mechanism or a non-sieving mechanism, and preferably by both a combined non-sieving and a sieving mechanism. The underlying porous hydrophobic filter membrane itself (before conversion to the composite hydrophobic filter membranes described herein) may exhibit effective sieving and non-sieving filtering properties, and desired flow properties. The composite filter membranes described herein can exhibit at least comparable sieving filtering properties, useful or comparable (not unduly diminished) flow properties, and improved (e.g., substantially improved) non-sieving filtering properties relative to the underlying hydrophobic polymeric membranes utilized as starting materials.

A filter membrane of the present description can be useful with any type of industrial or life sciences process that requires a high purity liquid material as an input. Non-limiting examples of such processes include processes of preparing microelectronic or semiconductor devices, a specific example of which is a method of filtering a liquid process material (e.g., solvent or solvent-containing liquid) used for semiconductor photolithography. Examples of contaminants present in a process liquid or solvent used for preparing microelectronic or semiconductor devices may include metal ions dissolved in the liquid, solid particulates suspended in the liquid, and gelled or coagulated materials (e.g., generated during photolithography) present in the liquid.

Particular examples of filter membranes as described can be used to purify a liquid chemical that is used or useful in a semiconductor or microelectronic fabrication application, e.g., for filtering a liquid solvent or other process liquid used in a method of semiconductor photolithography. Some specific, non-limiting, examples of solvents that can be filtered using a filter membrane as described include: n-butyl acetate (nBA), isopropyl alcohol (IPA), 2-ethoxyethyl acetate (2EEA), a xylene, cyclohexanone, ethyl lactate, methyl isobutyl carbinol (MIBC), methyl Isobutyl Ketone (MIBK), isoamyl acetate, undecane, propylene glycol methyl ether (PGME), and propylene glycol monomethyl ether acetate (PGMEA), and a mixed solution of propylene glycol monomethyl ether (PGME) and PGMEA (7:3)). Example filter membranes as described may be effective to remove metals from solvents that contain water, amines, or both, e.g., bases and aqueous bases such as NH₄OH, tetramethyl ammonia hydroxide (TMAH) and comparable solutions, which may optionally contain water. In some embodiments liquid including a solvent selected from: tetramethyl ammonium hydroxide (TMAH) or NH₄OH is pass through a filter having a membrane described herein and removes metal from the solvent. In some embodiments, passing the solvent-containing liquid through the membrane to remove metal from the solvent-containing liquid results in a concentration of metal in the solvent-containing liquid being reduced.

The composite filter membranes disclosed herein can also be characterized in terms of dye-binding capacity of the filter membrane. Specifically, a charged dye can be caused to bind to surfaces of the filtration membrane. The amount of the dye that can be bound to the filtration membrane can be measured quantitatively by spectroscopic methods based on a difference in measured absorption readings of the membrane at an absorption frequency of the dye. The dye-binding capacity can be assessed by use of a negatively-charged dye, and also by use of a positively-charged dye.

The composite filter membranes of the first aspect may in certain embodiments have a dye-binding capacity for methylene blue dye that is at least 1 microgram per centimeter squared of the filter membrane (μg/cm²), e.g., greater than 1, or 10 μg/cm²; alternately or in addition, a coated filter membrane as described may have a dye-binding capacity for Ponceau-S dye that is about 1 to 10 μg/cm², e.g., greater than 1 to 10, or about 5 μg/cm² and capacity to bind methylene blue dye (MB DBC) of between 1 and 10 μg/cm².

The composite filter membranes of the second aspect may in certain embodiments have a dye-binding capacity for methylene blue dye that is at least 1 microgram per centimeter squared of the filter membrane (μg/cm²), e.g., greater than 1, 10, 100, or 500 μg/cm²; alternately or in addition, a coated filter membrane as described may have a dye-binding capacity for Ponceau-S dye that is at least 1 μg/cm², e.g., greater than 1, 10, 100, or 500 μg/cm².

In addition, a filter membrane as described can be characterized by a flow rate or flux of a flow of liquid through the filter membrane. The flow rate must be sufficiently high to allow the filter membrane to be efficient and effective for filtering a flow of fluid through the filter membrane. A flow rate, or as alternately considered, a resistance to a flow of liquid through a filter membrane, can be measured in terms of flow rate or flow time. A filter membrane as described herein, can have a relatively low flow time, preferably in combination with a bubble point that is relatively high, and good filtering performance (e.g., as measured by particle retention, dye-binding capacity, or both). An example of a useful or preferred isopropanol flow time can be below about 20,000 seconds/500 mL, e.g., below about 4,000 or 2,000 seconds/500 mL.

Membrane isopropanol (IPA) flow times as reported herein are determined by measuring the time it takes for 500 ml of isopropyl alcohol (IPA) fluid to pass through a membrane with an effective surface area of 13.8 cm² at 14.2 psi, and at a temperature of 21 degrees Celsius.

In certain embodiments, the composite membranes described herein can be approximately equal to or greater than a flow time of the same filter membrane that does not contain the polyamide coating and co-reacted crosslinker/monomer coating. In other words, the creation of the composite membranes from the underlying porous hydrophobic filter membranes does not have a substantial negative impact on the flow properties of the filter membrane, yet may still improve the filtering function of the filter membrane, especially the non-sieving filtering function of the membrane, e.g., as measured by dye-binding capacity, particle retention, or both, depending on the pore size.

A filter membrane as described can be contained within a larger filter structure such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid chemical to cause at least a portion of the flow of the liquid chemical to pass through the filter membrane, so that the filter membrane removes an amount of the impurities or contaminants from the liquid chemical. The structure of a multi-layer filter assembly or filter cartridge may include one or more of various additional materials and structures that support the composite filter membrane within the filter assembly or filter cartridge to cause fluid to flow from a filter inlet, through the composite membrane (including the filter layer), and thorough a filter outlet, thereby passing through the composite filter membrane when passing through the filter. The filter membrane supported by the filter assembly or filter cartridge can be in any useful shape, e.g., a pleated cylinder, a cylindrical pad, one or more non-pleated (flat) cylindrical sheets, a pleated sheet, among others.

One example of a filter structure that includes a filter membrane in the form of a pleated cylinder can be prepared to include the following component parts, any of which may be included in a filter construction but may not be required: a rigid or semi-rigid core that supports a pleated cylindrical coated filter membrane at an interior opening of the pleated cylindrical coated filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric material.

The detailed description and the drawings, which are not necessarily to scale, depict illustrative embodiments and are not intended to limit the scope of the embodiments described herein. The illustrative embodiments depicted are intended only as exemplary. Selected features of any illustrative embodiment may be incorporated into an additional embodiment unless clearly stated to the contrary.

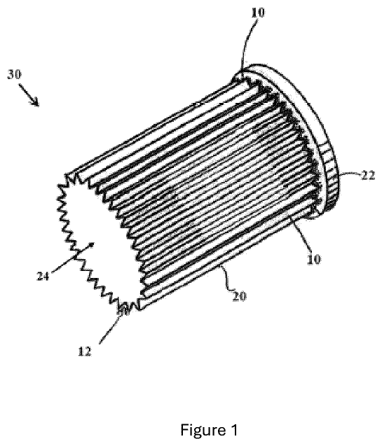

As one example, FIG. 1 shows filter component 30, which is a product of pleated cylindrical component 10 and end piece 22, with other optional components. Cylindrical component 10 includes a filter membrane 12, as described herein, and is pleated. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 30. The resultant pleated cylindrical component 30 with two opposed potted ends and optional core and cage can then be placed into a filter housing that includes an inlet and an outlet and that is configured so that an entire amount of a fluid entering the inlet must necessarily pass through filtration membrane 12 before exiting the filter at the outlet.

“Particle retention” or “coverage” refers to the percentage of the number of particles that can be removed from a fluid stream by a membrane placed in the fluid pathway of the fluid stream. Particle retention determined according to the following procedure is referred to as the “Particle Retention Test”. An aqueous feed solution of 0.1% Triton X-100 having a pH of about 5, containing 8 ppb polystyrene particles having a diameter of 25 nm (available from Duke Scientific G25B) and 0.5 M NaCl is prepared. Particle retention of a 47 mm membrane disc can be measured by passing a sufficient amount of the aqueous feed solution to achieve 1% monolayer coverage through the membrane at a constant flow of 7 mL/min and collecting the filtrate. The particle retention can be determined for different monolayer percentages, such as 0.5%, 1%, 2%, 3%, 4%, or 5%. To accurately determine the particle retention, the process is calibrated to determine the concentration of polystyrene particles in a feed stream that does not pass through a membrane. The concentration of the polystyrene particles in the filtrate and the feed stream can be calculated from the absorbance of the filtrate using a fluorescence spectrophotometer. Particle retention is then calculated using the following equation:

$$particle retention = \frac{[ feed ] - [ filtrate ]}{[ feed ]} \times 100 \%$$

The number (#) of particles necessary to achieve 1% monolayer coverage can be calculated from the following equation:

$$\# of particles for n \% monolayer = \frac{a}{( \frac{\sqrt{3}}{2} ) {( dp )}^{2}} \times \frac{n}{100}$$

wherein
   a=effective membrane surface area (in mm²)
   dₚ=diameter of the particle (in mm)
   n=the % monolayer

In some embodiments, the membranes disclosed herein have a particle retention as determined by the Particle Retention Test at a 1% monolayer in a range from about 75% to about 100%, about 75% to about 99%, about 75% to about 95%, about 75% to about 90%, about 80% to about 100%, about 80% to about 99%, about 80% to about 95%, about 80% to about 90%, about 85% to about 100%, about 85% to about 99%, about 85% to about 95%, about 85% to about 90%, about 90% to about 100%, about 90% to about 99%, about 90% to about 95%, and all ranges and sub-ranges therebetween. In some embodiments, the membranes disclosed herein have a particle retention as determined by the Particle Retention Test at a 3% monolayer in a range from about 70% to about 100%, about 70% to about 99%, about 70% to about 95%, about 70% to about 90%, about 75% to about 100%, about 75% to about 99%, about 75% to about 95%, about 75% to about 90%, about 80% to about 100%, about 80% to about 99%, about 80% to about 95%, about 80% to about 90%, about 85% to about 100%, about 85% to about 99%, about 85% to about 95%, about 85% to about 90%, about 90% to about 100%, about 90% to about 99%, about 90% to about 95%, and all ranges and sub-ranges therebetween.

### EXAMPLES

### Porosimetry Bubble Point

A porosimetry bubble point test method measures the pressure required to push air through the wet pores of a membrane. A bubble point test is a well-known method for determining the pore size of a membrane. To determine the bubble point of a porous material a sample of the porous material is immersed in and wetted with ethoxy-nonafluorobutane HFE 7200 (available from 3M) at a temperature of 20-25 degrees Celsius (e.g., 22 degrees Celsius). A gas pressure is applied to one side of the sample by using compressed air and the gas pressure is gradually increased. The minimum pressure at which the gas flows through the sample is called the bubble point.

As used herein, a “surface energy” (surface free energy) of a surface is considered to be equal to a surface tension of highest surface tension liquid that will wet the surface within two seconds of contact (see Example 3, Surface Energy Measurement) (also referred to as a “wetting liquid surface tension” test, or a “standard liquid” test), and generally corresponds to the relative hydrophobicity/hydrophilicity of the surface. In certain embodiments, the membrane will have a surface energy that greater than about 30 dynes per centimeter, measured as a surface tension of a highest surface tension liquid that will wet the surface within two seconds, as described in Example 3.

### Example 1—Preparation of an Asymmetric 5 Nm UPE Membrane Coated With Nylon 6

A coating solution of 3 weight percent Nylon 6 was prepared by dissolving 3 g of Nylon 6 resin in 77 g of 98% Formic acid and 20 g of Isopropanol. A 47 mm disk of asymmetric 5 nm UPE membrane was wet for 10 seconds with the coating solution. The membrane disk was removed from the Nylon 6 solution and placed between two polyethylene sheets. Excess solution was removed from the membrane by rolling a rubber roller over the polyethylene sandwich as it lays flat on a table. The membrane disk was removed from the sandwich and immediately placed in deionized water solution where it was submerged for 2 minutes to cause the Nylon to phase separate into the asymmetric 5 nm UPE membrane. The membrane disk was removed from the DI water solution and immediately submerged in 100% Methanol solution for 2 min. The membrane was restrained in a holder and placed in an oven set at 60° C. for 10 minutes. Prior to coating with Nylon 6, the asymmetric 5 nm UPE membrane had an HFE mean bubble point of 112 psi, IPA flowtime of 4,234 sec/500 mL, thickness of 55 um, and Ponceau-S dye binding capacity of 0.0 ug/cm². The resulting Nylon 6 coated UPE membrane had an ethoxy-nonafluorobutane HFE 7200 mean bubble point of 114 psi, IPA flowtime of 5,264 sec/500 mL, thickness of 54 um, and Ponceau-S dye binding capacity of 2.5 ug/cm².

### Example 2: Retention UPE Membranes Coated With Nylon 6

47 mm disks of asymmetric of 3 nm, 5 nm, and 10 nm UPE membrane were coated with a 3 weight percent Nylon 6 solution as described in Example 1. The Particle Retention Test described above was then measured for coated and uncoated 3 nm, 5 nm, and 10 nm UPE membranes. The results are shown in Table 1 below.

TABLE 1

| | Particle Retention (%) at Specified Monolayers | | | | |
|---|---|---|---|---|---|
| Membranes | 0.5% | 1% | 2% | 3% | 4% |
| UPE 3 nm | 90.7 | 82.4 | 45.1 | 35.7 | 31.8 |
| UPE 3 nm | 95.5 | 95.1 | 93.5 | 92.3 | 88.8 |
| coated | | | | | |
| UPE 5 nm | 87.2 | 67.6 | 31.6 | 29.5 | 28.5 |
| UPE 5 nm | 93.8 | 92.8 | 91.3 | 88.6 | 83.7 |
| coated | | | | | |
| UPE 10 nm | 67.6 | 51.2 | 26.8 | 20.9 | 17.8 |
| UPE 10 nm | 80.3 | 78.3 | 77.1 | 75.8 | 70.8 |
| coated | | | | | |

As can be seen the coating the 3 nm, 5 nm, and 10 nm UPE membrane improved the particle retention at each monolayer percentage compared to the uncoated 3 nm, 5 nm, and 10 nm UPE membrane.

### Example 2—Preparation of an Asymmetric 5 Nm UPE Membrane Coated With Nylon 6 and a UV Cured Monomer Coating

A coating solution of 3 weight percent Nylon 6 was prepared by dissolving 3 g of Nylon 6 resin in 77 g of 98% Formic acid and 20 g of Isopropanol. A 47 mm disk of asymmetric 5 nm UPE membrane was wet for 10 seconds with the coating solution. The membrane disk was removed from the Nylon 6 solution and placed between two polyethylene sheets. Excess solution was removed from the membrane by rolling a rubber roller over the polyethylene sandwich as it lays flat on a table. The membrane disk was removed from between the polyethylene sheets and immediately placed in deionized water solution where it was submerged for 2 minutes to cause the Nylon to phase separate into the asymmetric 5 nm UPE membrane. The membrane disk was removed from the DI water solution and immediately submerged in a monomer solution containing 0.2% Irgacure 2959, 0.2% MBAM (N, N′-methylenebis(acrylamide)), 0.5% APTAC((3-acrylamidopropyl)trimethylammonium chloride solution, available from Sigma-Aldrich), and 5% Methanol. The membrane disk was removed from the monomer solution and placed between two polyethylene sheets. Excess solution was removed from the membrane by rolling a rubber roller over the polyethylene sandwich as it lays flat on a table. The polyethylene sandwich was then taped to a transport unit which conveyed the assembly through a Fusion Systems broadband UV exposure lab unit emitting at wavelengths from 200 nm to 600 nm. Time of exposure is controlled by how fast the assembly moves through the UV unit. In this example, the assembly moved through the UV chamber at 10 feet per minute. After UV exposure the membrane disk was removed from between the polyethylene sandwich and immediately placed in 100% Methanol solution for 2 min. The membrane was restrained in a holder and placed in an oven set at 60° C. for 10 minutes. Prior to coating with Nylon 6, the asymmetric 5 nm UPE membrane had an ethoxy-nonafluorobutane HFE 7200 mean bubble point of 112 psi, IPA flowtime of 4,234 sec/500 mL,, thickness of 55 um, and Ponceau-S dye binding capacity of 0.0 ug/cm². The resulting Nylon 6 coated and UV cured monomer UPE membrane had an HFE mean bubble point of 114 psi, IPA flowtime of 10,278 sec/500 mL, thickness of 53 um, and Ponceau-S dye binding capacity of 6.5 ug/cm².

### Example 3—Surface Energy Measurement

A liquid will wet a porous polymeric membrane when the surface tension of the liquid is less than the surface free energy of the membrane. For purposes of this disclosure, a porous membrane is wet by a liquid when the membrane is placed in contact with the highest surface tension liquid within a series of inert (standard) liquids, and the membrane spontaneously wicks a liquid within 2 seconds or less without the application of external pressure.

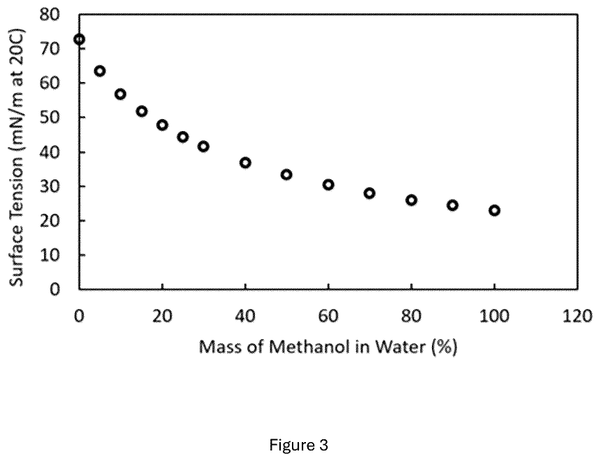

In a representative example, a series of inert (standard) liquids was prepared by mixing methanol and water at different mass ratios. The surface tension of the resulting liquids is depicted in FIG. 3 (Plotted using surface tension data published in Lange's Handbook of Chemistry 11 edition).

A 47 mm disc of the membranes prepared according to Examples 1 was placed in contact with the inert liquids, one liquid at a time, in a beaker. For each liquid, the amount of time required for the membrane to spontaneously wick the liquid was recorded. A liquid of 58% Methanol with 30.32 mN/m surface tension and 22% Methanol with 47.86 mN/m surface tension were the highest surface tension liquid that wet the UPE and UPE coated membrane respectively, within 2 seconds or less.

A 47 mm disc of the membranes prepared according to Example 2 was placed in contact with the inert liquids, one liquid at a time, in a beaker. For each liquid, the amount of time required for the membrane to spontaneously wick the liquid was recorded. A liquid of 58% Methanol with 30.32 mN/m surface tension and 16% Methanol with 51.83 mN/m surface tension were the highest surface tension liquid that wet the UPE and UPE coated membrane respectively, within 2 seconds or less.

### Example 4—Reduction of Metals in PGMEA by Nylon Membrane, Asymmetric 5 Nm UPE Membrane Coated With Nylon 6, and Asymmetric 5 Nm UPE Membrane Coated With Nylon 6 and a UV Cured Monomer Coating

This example demonstrates the ability of 5 nm asymmetric UPE membranes coated with Nylon 6 or Nylon 6 and a UV cured monomer to reduce metals in PGMEA during filtration. The metal reduction performance is compared to a 5 nm pore size Nylon 6 membrane.

The Nylon 6 coated UPE membranes were prepared using a method similar to Example 1 and Example 2 and cut into 47 mm membrane coupons. These membrane coupons were conditioned by washing several times with 0.35% HCl followed by deionized water and secured into a clean 47 mm Filter Assembly (Savillex). The membrane and filter assembly were flushed with Isopropanol Gigabit (KMG) followed by flushing with PGMEA. As a control sample a 5 nm Nylon 6 membrane was also prepared and conditioned and secured into a filter assembly using the same method. The application solvent, PGMEA, was spiked with CONOSTAN Oil Analysis Standard S-21 (SCP Science) at a target concentration of 13.59 ppb total metals. To determine the filtration metal removal efficiency the metal spiked application solvents were passed through the corresponding 47 mm filter assembly containing each filter at 10 mL/min and the filtrate was collected into a clean PFA jar at 50, 100, and 150 mL. The metal concentration for the metal spiked application solvent and each filtrate sample was determined using ICP-MS. The results are tabulated in the Table 4.1: Metal Reduction in PGMEA. The results show that 5 nm Nylon 6 Membrane is able to reduce total metals from 13.59 ppb to 4.79 ppb after 150 mL, Asymmetric 5 nm UPE Membrane Coated with Nylon 6 is able to reduce total metals from 13.59 ppb to 5.43 ppb after 150 mL, and Asymmetric 5 nm UPE Membrane Coated with Nylon 6 and a UV Cured Monomer Coating is able to reduce total metals from 13.59 ppb to 3.26 ppb after 150 mL.

TABLE 4.1
Metal Reduction in PGMEA

| | Sample | | | | | | | | | |
|---|---|---|---|---|---|---|---|---|---|---|
| | | | | | | | | Asymmetric 5 nm UPE | | |
| | | | | | | | | Membrane Coated with Nylon | | |
| | | | | | Asymmetric 5 nm UPE | | | 6 and a UV Cured Monomer | | |
| | PGMEA | 5 nm Nylon 6 Membrane | | | Membrane Coated with Nylon 6 | | | Coating | | |
| Volume | Feed | 50 mL | 100 mL | 150 mL | 50 mL | 100 mL | 150 mL | 50 mL | 100 mL | 150 mL |
| Li | 0.13 | 0.13 | 0.13 | 0.13 | 0.13 | 0.13 | 0.13 | 0.13 | 0.13 | 0.13 |
| B | 0.59 | 0.44 | 0.35 | 0.40 | 0.44 | 0.49 | 0.46 | 0.39 | 0.31 | 0.38 |
| Na | 0.87 | 0.16 | 0.16 | 0.11 | 0.16 | 0.61 | 0.69 | 0.11 | 0.26 | 0.23 |
| Mg | 0.74 | 0.51 | 0.32 | 0.29 | 0.32 | 0.32 | 0.26 | 0.24 | 0.24 | 0.24 |
| Al | 0.62 | 0.46 | 0.40 | 0.37 | 0.42 | 0.38 | 0.33 | 0.30 | 0.31 | 0.30 |
| K | 0.15 | 0.14 | 0.14 | 0.12 | 0.12 | 0.13 | 0.12 | 0.13 | 0.13 | 0.12 |
| Ca | 0.70 | 0.41 | 0.31 | 0.25 | 0.34 | 0.33 | 0.25 | 0.12 | 0.12 | 0.11 |
| Ti | 0.49 | 0.43 | 0.41 | 0.36 | 0.41 | 0.35 | 0.34 | 0.33 | 0.33 | 0.33 |
| V | 1.05 | 0.59 | 0.45 | 0.40 | 0.43 | 0.43 | 0.39 | 0.09 | 0.10 | 0.14 |
| Cr | 0.72 | 0.57 | 0.52 | 0.54 | 0.30 | 0.29 | 0.28 | 0.17 | 0.19 | 0.19 |
| Mn | 0.85 | 0.12 | 0.10 | 0.09 | 0.09 | 0.09 | 0.08 | 0.08 | 0.08 | 0.08 |
| Fe | 0.79 | 0.70 | 0.64 | 0.69 | 0.41 | 0.58 | 0.56 | 0.12 | 0.22 | 0.34 |
| Ni | 0.88 | 0.27 | 0.19 | 0.15 | 0.19 | 0.17 | 0.15 | 0.13 | 0.13 | 0.13 |
| Cu | 0.80 | 0.05 | 0.04 | 0.04 | 0.05 | 0.04 | 0.04 | 0.02 | 0.02 | 0.01 |
| Zn | 0.86 | 0.03 | <0.001 | <0.001 | <0.001 | <0.001 | <0.001 | <0.001 | <0.001 | <0.001 |
| Mo | 0.65 | 0.43 | 0.28 | 0.21 | 0.35 | 0.20 | 0.22 | 0.11 | 0.10 | 0.12 |
| Ag | 0.13 | 0.04 | 0.04 | 0.04 | 0.05 | 0.04 | 0.04 | 0.04 | 0.04 | 0.04 |
| Cd | 0.73 | 0.24 | 0.17 | 0.14 | 0.16 | 0.16 | 0.13 | 0.13 | 0.13 | 0.13 |
| Sn | 0.50 | 0.32 | 0.23 | 0.18 | 0.23 | 0.14 | 0.11 | 0.07 | 0.07 | 0.07 |
| Ba | 0.47 | 0.19 | 0.18 | 0.18 | 0.19 | 0.20 | 0.18 | 0.17 | 0.17 | 0.17 |
| Pb | 0.86 | 0.07 | 0.08 | 0.09 | 0.08 | 0.60 | 0.67 | <0.001 | 0.00 | <0.001 |
| Total | 13.59 | 6.30 | 5.12 | 4.79 | 4.85 | 5.68 | 5.43 | 2.87 | 3.08 | 3.26 |
| (ppb) | | | | | | | | | | |

The results show that the UPE membrane coated with Nylon 6 generally had better metals removal than the Nylon 6 control membrane and the UPE membrane coated with Nylon 6 and a UV cured monomer has better metal removal than both the Nylon 6 control membrane and the UPE membrane coated with Nylon 6.

### Aspects of the Disclosure

In a first aspect, the disclosure provides a composite porous filter membrane comprising:
a porous hydrophobic polymeric filter media having a coating thereon, wherein said coating is a polyamide polymer which is soluble in formic acid, wherein said membrane has:
   i. a surface energy of greater than about 30 dynes/cm; and
   ii. an isopropanol flow time of about 150 to about 20,000 seconds/500 mL, measured at 14.2 psi.

In a second aspect, the disclosure provides a composite porous filter membrane comprising:
a porous hydrophobic polymeric filter media having a coating thereon, wherein said coating is a polyamide polymer which is soluble in formic acid, wherein said membrane has:
   i. a surface energy of greater than about 30 dynes/cm; and
   ii. a particle retention at a 3% monolayer in a range from about 70% to about 100%.

In a third aspect, the disclosure provides the filter membrane of the first or second aspect, wherein the membrane has a particle retention at a 3% monolayer in a range from about 80% to about 100%.

In a fourth aspect, the disclosure provides the filter membrane of any of the preceding aspects, wherein said membrane has a bubble point of about 20 to about 200 psi, when measured using ethoxy-nonafluorobutane HFE 7200 at a temperature of about 22° C.

In a fifth aspect, the disclosure provides the filter membrane of any of the preceding aspects, wherein said membrane has the capacity to bind Ponceau S dye of between about 1 and about 10 μg/cm² and capacity to bind methylene blue dye (MB DBC) of between about 1 and about 10 μg/cm².

In a sixth aspect, the disclosure provides the filter membrane of any of the preceding aspects, wherein the hydrophobic polymeric filter media is chosen from polyethylene, polypropylene, polycarbonate, poly(tetrafluoro ethylene), polyvinylidene fluoride, and polyarylsulfone.

In a seventh aspect, the disclosure provides the filter membrane of any of the preceding aspects, wherein the hydrophobic polymeric filter media is chosen from ultrahigh molecular weight polyethylene and poly(tetrafluoro ethylene).

In an eighth aspect, the disclosure provides the filter membrane of any of the preceding aspects, wherein the surface energy is about 30 to about 100 dynes/cm.

In a ninth aspect, the disclosure provides the filter membrane of any one of any of the preceding aspects, wherein the polyamide polymer is comprised of at least one of (i) a copolymer of hexamethylene diamine and adipic acid; (ii) a homopolymer of polycaprolactam; (iii) copolymers of hexamethylene diamine and sebacic acid; and (iv) copolymers of tetramethylenediamine and adipic acid.

In a tenth aspect, the disclosure provides the filter membrane of any of the preceding aspects, wherein the polyamide polymer has a number average molecular weight of about 15,000 to about 42,000 Daltons.

In an eleventh aspect, the disclosure provides the filter membrane of any of the preceding aspects, wherein said membrane:
(i) has a bubble point of about 50 to 150 psi, when measured using ethoxy-nonafluorobutane HFE 7200 at a temperature of about 22° C.;
(ii) an isopropanol flowtime of about 6,000 to about 10,000 seconds/500 mL, measured at 14.2 psi; and
(iii) capacity to bind Ponceau S dye of about 8 to about 10 μg/cm² and capacity to bind methylene blue dye (MB DBC) of between 1 and 100 μg/cm².

In a twelfth aspect, the disclosure provides a composite porous filter membrane comprising a porous hydrophobic polymeric filter membrane having coated thereon a polyamide coating as a first coating, wherein said polyamide is soluble in formic acid, thereby providing a polyamide-coated membrane, and wherein said polyamide-coated membrane has a second coating thereon, which is the free-radical reaction product of (i) at least one crosslinker; and (ii) at least one monomer, in the presence of a photo-initiator.

In a thirteenth aspect, the disclosure provides the membrane of the twelfth aspect, wherein the hydrophobic polymeric filter media is chosen from polyethylene, polypropylene, polycarbonate, poly(tetrafluoro ethylene), polyvinylidene fluoride, and polyarylsulfone.

In a fourteenth aspect the disclosure provides the membrane of the twelfth or thirteenth aspect, wherein the membrane has a particle retention at a 3% monolayer in a range from about 70% to about 100% or in a range from about 80% to about 100%.

In a fifteenth aspect, the disclosure provides the membrane of any one of the twelfth to fourteenth aspects, wherein the surface energy is about 30 to about 85 dynes/cm.

In a sixteenth aspect, the disclosure provides the membrane of any of the twelfth to fifteenth aspects, wherein the hydrophobic polymeric filter media is chosen from ultrahigh molecular weight polyethylene and poly(tetrafluoro ethylene).

In a seventeenth aspect, the disclosure provides the membrane of any of the twelfth to seventeenth aspects, wherein said membrane:
(i) has an isopropanol flowtime of about 150 to about 20,000 seconds/500 mL, measured at 14.2 psi;
(ii) has a bubble point of about 20 to about 200 psi, when measured using ethoxy-nonafluorobutane HFE 7200 at a temperature of about 22° C.; and
(iii) has the capacity to bind Ponceau S dye of between about 1 and about 30 μg/cm² and capacity to bind methylene blue dye (MB DBC) of between about 1 and about 30 μg/cm².

In an eighteenth aspect, the disclosure provides the membrane of any one of the twelfth through seventeenth aspects, wherein the polyamide is comprised of at least one of (i) a copolymer of hexamethylene diamine and adipic acid; (ii) a homopolymer of polycaprolactam; (iii) copolymers of hexamethylene diamine and sebacic acid; and (iv) copolymers of tetramethylenediamine and adipic acid.

In a nineteenth aspect, the disclosure provides the membrane of any one of the twelfth through nineteenth aspects, wherein the polyamide polymer has a number average molecular weight of about 15,000 to about 42,000 Daltons.

In a twentieth aspect, the disclosure provides the membrane of any one of the twelfth through nineteenth aspects, wherein the crosslinker is chosen from methylene bis(acrylamide), tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione, and ethylene glycol divinyl ether.

In a twenty-first aspect, the disclosure provides the membrane of any one of the twelfth through twentieth aspects, wherein the monomer is chosen from 2-(dimethylamino)ethyl hydrochloride acrylate, [2-(acryloyloxy)ethyl]trimethylammonium chloride, 2-aminoethyl methacrylate hydrochloride, N-(3-aminopropyl) methacrylate hydrochloride, 2-(dimethylamino)ethyl methacrylate hydrochloride, [3-(methacryloylamino)propyl]trimethylammonium chloride solution, [2-(methacryloyloxy)ethyl]trimethylammonium chloride, acrylamidopropyl trimethylammonium chloride, 2-aminoethyl methacrylamide hydrochloride, N-(2-aminoethyl) methacrylamide hydrochloride, N-(3-aminopropyl)-methacrylamide hydrochloride, diallyldimethylammonium chloride, allylamine hydrochloride, vinyl imidazolium hydrochloride, vinyl pyridinium hydrochloride, vinyl benzyl trimethyl ammonium chloride, and acrylamido propyl trimethylammonium chloride, 2-ethylacrylic acid, acrylic acid, 2-carboxy ethyl acrylate, 3-sulfopropyl acrylate potassium salt, 2-propyl acrylic acid, 2-(trifluoromethyl)acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-l-propanesulfonic acid, 3-methacrylamido phenyl boronic acid, vinyl sulfonic acid, and vinyl phosphonic acid.

In a twenty-second aspect, the disclosure provides the membrane of any one of the twelfth through twenty-first aspects, wherein the monomer is chosen from 2-ethylacrylic acid, acrylic acid, 2-carboxy ethyl acrylate, 3-sulfopropyl acrylate potassium salt, 2-propyl acrylic acid, 2-(trifluoromethyl)acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-l-propanesulfonic acid, 3-methacrylamido phenyl boronic acid, vinyl sulfonic acid, and vinyl phosphonic acid.

In a twenty-third aspect, the disclosure provides the membrane of any one of the twelfth through twenty-second aspects, wherein the monomer is chosen from acryl amide, N,N dimethyl acrylamide, N-(hydroxyethyl)acrylamide, diacetone acrylamide, N-[tris(hydroxymethyl)methyl]acrylamide, N-(isobutoxymethyl)acrylamide, N-(3-methoxypropyl)acrylamide, 7-[4-(trifluoromethyl)coumarin]acrylamide, N-isopropyl acrylamide, 2-(dimethylamino)ethyl acrylate, 1,1,1,3,3,3-hexafluoroisopropyl acrylate, ethyl acrylate, 2-hydroxyethyl acrylate, butyl acrylate, ethylene glycol methyl ether acrylate, 4-hydroxybutyl acrylate, hydroxypropyl acrylate, 4-acetoxyphenethyl acrylate, benzyl acrylate, 1-vinyl-2-pyrrolidinone, vinyl acetate, ethyl vinyl ether, vinyl 4-tert-butylbenzoate, and phenyl vinyl sulfone.

In a twenty-fourth aspect, the disclosure provides a method for preparing the composite porous filter membrane of any one of the first through ninth aspects, which comprises:
a. dissolving a polyamide polymer in formic acid to form a polyamide solution,
b. contacting a porous hydrophobic polymeric filter media with said polyamide solution to provide a polyamide-coated membrane,
c. submerging said polyamide-coated membrane in a solution comprising water,
d. rinsing said polyamide-coated membrane in C₁-C₄ alcohols and water, and
e. drying said polyamide-coated membrane.

In a twenty-fifth aspect, the disclosure provides a method for preparing the composite porous filter membrane of any one of the tenth through twentieth aspects, which comprises:
a. dissolving a hydrophilic polyamide polymer in formic acid to form a polyamide solution,
b. contacting a porous hydrophobic polymeric filter media with said polyamide solution to provide a polyamide-coated membrane,
c. submerging said polyamide-coated membrane in a monomer solution comprising water, at least one crosslinker, at least one monomer, and at least one photo-initiator,
d. removing the resulting membrane from said bath, and applying ultraviolet radiation, followed by
e. rinsing said polyamide-coated membrane in rinsing baths comprising solvents selected from water and C₁-C₄ alcohols, and
f. drying said composite porous filter membrane.

In a twenty-sixth aspect, the disclosure provides a method for removing an impurity from a liquid, which comprises contacting the liquid with the composite membrane of any one of the first through nineteenth aspects.

In a twenty-seventh aspect, the disclosure provides the method of the twenty-sixth aspect, wherein the impurity is chosen from one or more metal or metalloid ions.

In a twenty-eighth aspect, the disclosure provides the method of the twenty-seventh aspect, wherein the impurity is chosen from one or more ions of lithium, boron, sodium, magnesium, aluminum, potassium, calcium, titanium, vanadium, chromium, manganese, iron, nickel, copper, zinc, molybdenum, silver, cadmium, tin, barium, and lead.

In a twenty-ninth aspect, the disclosure provides a filter comprising the membrane of any one of the first through the eleventh aspects.

In a thirtieth aspect, the disclosure provides a filter comprising the membrane of any one of the twelfth through twenty-third aspects.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in details without exceeding the scope of the disclosure. The disclosure's scope is, of course, defined in the language in which the appended claims are expressed.

What is claimed is:

1. A method for preparing a composite porous filter membrane comprising:
forming a polyamide solution by dissolving a polyamide polymer in a solution comprising:
(i) a first component in which the polyamide polymer is soluble, and
(ii) a second component in which the polyamide polymer is less soluble;
contacting a porous hydrophobic polymeric filter media with the polyamide solution to provide a polyamide-coated membrane; and
submerging the polyamide-coated membrane in a solution comprising water;
rinsing the polyamide-coated membrane; and
drying the polyamide-coated membrane.

2. The method of claim 1 wherein the first component is formic acid and the second component is isopropanol.

3. The method of claim 1 wherein the polyamide polymer comprises nylon 6,6, nylon 6, nylon 610, or nylon 46.

4. The method of claim 1 comprising after submerging:
additionally submerging the polyamide-coated membrane in a monomer solution comprising at least one crosslinker, at least one monomer, and at least one photo-initiator;
removing the resulting membrane from the monomer solution; and
applying electromagnetic radiation.

5. A membrane prepared according to the method of claim 1.

6. A membrane prepared according to the method of claim 4.

7. A composite porous filter membrane comprising:
a porous hydrophobic polymeric filter media having a porous coating with a polyamide polymer which at least partially coats surfaces throughout the porous hydrophobic polymeric filter media;
the composite porous filter membrane having a surface energy of greater than about 30 dynes/cm.

8. The composite porous filter membrane of claim 7 wherein the polyamide polymer comprises nylon 6,6, nylon 6, nylon 610, or nylon 46.

9. The composite porous filter membrane of claim 7 wherein the surface energy is about 30 dynes/cm to about 100 dynes/cm.

10. The composite porous filter membrane of claim 7 having an additional coating thereon which is the free-radical reaction product of at least one crosslinker and at least one monomer in the presence of a photoinitiator.

11. The composite porous filter membrane of claim 10 wherein the surface energy is about 30 dynes/cm to about 85 dynes/cm.
